(19) United States
(12) Patent Application Publication
(10) Pub. No.: US 2026/0220607 A1
(43) Pub. Date: Jul. 30, 2026

(54) PROFILE-BASED DATA AGGREGATION FOR DYNAMIC DOCUMENT GENERATION

(71) Applicant: Bold Limited, Hamilton (BM)

(72) Inventors: John GLASE, San Juan, PR (US); James FREUNDLICH, San Juan, PR (US)

(21) Appl. No.: 19/038,282

(22) Filed: Jan. 27, 2025

(51) Int. Cl. G06Q 10/1053; G06F 16/9535; G06F 16/955

(52) U.S. Cl. CPC G06Q 10/1053; G06F 16/9535; G06F 16/9558

(57) ABSTRACT

Certain aspects of the disclosure provide methods of generating resumes based on user profile data for online job applications. In certain aspects, the method includes receiving, from a user of a job listing service, a request to apply to a job posting using a user profile; generating, using information from the user profile of the user of the job listing service, a resume; creating, based on job posting data of the job posting and the information from the user profile, a job application for applying to the job posting; assembling a finalized job application comprising the job application and the generated resume; and applying, for the user, to the job posting by submitting the finalized job application.

### INTRODUCTION

### Technical Field

Aspects of the present disclosure relate to online job applications, and more particularly to profile-based data aggregation and dynamic resume generation for online job applications.

### Background

Organizations frequently rely upon online job applications as a primary mechanism for streamlining recruitment and hiring efforts. The shift to online job applications has facilitated the application process for candidates seeking to apply to multiple positions, but also has caused an increase in competition. Many online job portals prompt users to leverage both resumes and user profiles to showcase their skills and experience. Resumes and user profiles allow employers to quickly assess a candidate's qualifications, detailed work history, and expertise, while they sort through high volumes of job applications. How a user interacts with, manages, and leverages their professional user profiles and resumes has a significant impact on their experiences when engaging in job searches. There is an opportunity for providing improved techniques for online job applications, such as improving techniques for leveraging resumes and user profiles for online job applications.

### SUMMARY

Certain aspects provide a method comprising: receiving, from a user of a job listing service, a request to apply to a job posting using a user profile; generating, using information from the user profile of the user of the job listing service, a resume; creating, based on job posting data of the job posting and the information from the user profile, a job application for applying to the job posting; assembling a finalized job application comprising the job application and the generated resume; and applying, for the user, to the job posting by submitting the finalized job application.

Another aspect provides a method comprising: receiving, from a job listing service, one or more recommended job postings for a user based on a previously submitted job application; automatically applying to the one or more recommended job postings using a user profile by: generating, using information from the user profile of the user of the job listing service, a resume; creating, based job posting data of the one or more recommended job postings and the information from the user profile, a job application for applying to the one or more recommended job postings; assembling a finalized job application comprising the job application and the generated resume; and automatically applying, for the user, to the one or more recommended job postings by submitting the finalized job application.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an illustrative environment for implementing a job application generation system according to one or more aspects shown and described herein.

FIG. 2 depicts an illustrative system architecture implemented by a job application generation system to perform an illustrative process for generating a resume for a job application based on user profile data according to one or more aspects shown and described herein.

FIG. 3 depicts an illustrative job posting including an icon for requesting generation of a job application by a job application generation system according to one or more aspects shown and described herein.

FIG. 4 depicts an illustrative process implemented by a job application generation system for generating a populated job application based on user profile data according to one or more aspects shown and described herein.

FIG. 5 depicts an illustrative user profile according to one or more aspects shown and described herein.

FIG. 6 depicts an illustrative process implemented by a job application generation system for generating a resume based on user profile data according to one or more aspects shown and described herein.

FIG. 7 depicts an illustrative resume generated based on user profile data by a job application generation system implementing illustrative processes of generating a resume in accordance with one or more aspects shown and described herein.

FIG. 8 depicts an illustrative post-processing layer of a job application generation system for performing illustrative methods for post-processing of a generated resume according to one or more aspects shown and described herein.

FIG. 9 depicts an example method for generating a resume for a job application based on user profile data implemented by a job application generation system according to one or more aspects shown and described herein.

FIG. 10 depicts an example computing device upon which one or more aspects shown and described herein may be implemented.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating a resume for a job application based on user profile data. Techniques described herein utilize specially programmed computing device(s) to generate resumes based on user profile data, which may then be used to for an online job application.

Job listing services host a diverse set of job postings that may be derived from a wide variety of sources. This provides job seekers with large volumes of job listings that are consolidated into a single digital location. While certain job listing services allow users to create user profiles highlighting their experience and strengths, many organizations posting job listings further require the user to upload a professional resume or curriculum vitae (CV). Conventional techniques job listing services require job seekers to manually fill out forms with extensive amounts of personal and professional information—information that is often redundant of that saved as part of an online profile. Conventional techniques further require job seekers to utilize third-party software, which they may not have access to, to create a resume in a particular format, such as portable document format (PDF), and then to upload that document to an online portal. Conventional techniques further require job seekers to manually approve and finalize job applications. This limits users to only applying to online job postings for which they have the time to manually prepare, review, and submit applications. Thus, conventional techniques burden users with manual tasks that take extensive amounts of time, which dissuades users from actually completing job applications. Further, conventional techniques are prone to human error (e.g., when inputting information into the job application or the resume, during selecting and uploading of a resume, and during finalizing and submitting of the finalized job application), which can lead to inconsistent information between online profiles and resumes. Unfortunately, such inconsistencies may be held against a job seeker without the job poster realizing the underlying circumstances of the inconsistency, such as a job seeker that does not have regular access to the job listing service, or who makes an inadvertent data entry error while using unfamiliar third-party software.

In contrast, systems and methods of automatically generating resumes for online job applications based on a user profile are depicted and described herein. Such systems and methods provide technical solutions to the aforementioned problems by extracting information from a user profile and transforming the extracted information into a professional resume that may be automatically provided for a job listing. Aspects described herein may further automatically map the information extracted from the user profile to information fields of an electronic job application and populate the information fields without user interaction. Aspects described are thus technical solutions to the aforementioned technical problems of conventional techniques. In particular, aspects described herein automate processes previously performed manually by a user, reducing the amount of time a user must spend preparing a job application, and further reducing the risk of human error during generation of documents and information supporting a job application, such as a resume. Beneficially, aspects described herein perform multiple operations without user interaction, and thus provide the user with an improved experience. For example, while aspects may give the impression that a job application is submitted using only using a user's profile, in fact, aspects described herein create a resume automatically based on the user's profile and submit this information in the form of a properly generated finalized job application. These improved techniques for generating resumes for online job applications reduce the amount of time invested by the user, and further remove the risk of user error during the application process.

Described aspects further provide various technical benefits. As an example, described systems and methods for generating resumes for online job applications may generate resumes and finalized job applications having uniform and optimized formats, minimizing errors or incompatibilities during data transfer processes. The generated resumes and finalized job applications may further provide the technical benefit of reducing likelihood of failed submissions and improving compatibility with various applicant tracking system (ATS) platforms, reducing the need for additional processing or conversions that might slow down application handling by the entity from which an online job posting is derived. Furthermore, described aspects may lower the volume of unstructured file uploads by users, thereby reducing bandwidth used during submission processes. The technical benefits described above are merely illustrative. Additional technical benefits may be appreciated in view of illustrative systems and methods described herein.

### Example Systems and Methods for Generating Resumes from User Profile Data for Online Job Applications

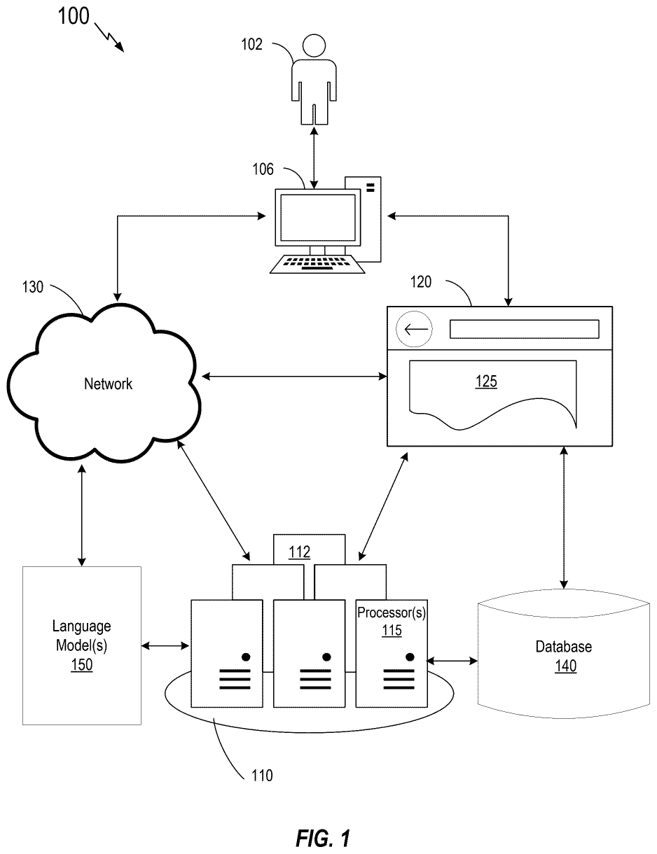

FIG. 1 depicts an illustrative environment 100 for implementing a job application generation system 110 for generating resumes from user profile data for online job applications according to one or more aspects shown and described herein.

Job application generation system 110 may be configured to interface with a user 102 seeking to apply to one or more online jobs. User 102 may interface with aspects of job application generation system 110, for example implemented by one or more computing devices, through a device 106. In certain aspects, device 106 may be a personal computer, a smart device (e.g., smartphone), or the like.

Device 106 may include a display device for implementing a user interface with the respective user, one or more processors for executing logic and one or more non-transitory computer-readable mediums for storing information and/or computer readable instructions. Device 106 operates as an interface for interacting with job application generation system 110 via a user interface 125 of a job listing service 120. In certain aspects, certain functionalities of the job application generation system 110 may be provided to user 102 via a suitable browser extension (e.g. provided by described aspects via one or more computing devices 112 described below) configured to display and overlay an icon within the user interface 125 of the job listing service 120 for allowing a user to make a request for triggering the performance of illustrative processes described herein. Device 106 may access job listing service 120 using any suitable data network 130. Job listing service 120 may include any web-based platform or application including a list of job postings derived from one or more sources. In some examples, job listing service 120 may directly employ and interface with job application generation system 110. In certain aspects, job listing service 120 may store registered user data, user profile data, and job posting data within a database 140 that is accessible by described aspects.

Job application generation system 110 may provide users the ability to apply to an online job posting of job listing service 120 using a profile. In particular, job application generation system 110 is configured to generate and upload a finalized job application including a generated resume based on the user's profile stored within job listing service 120.

Job application generation system 110 may further be configured to communicate with and leverage language model(s) 150, such as one or more artificial intelligence-based machine learning models including, but not limited to language models such as OpenAI's ChatGPT, NeMO™ LLM from NVIDIA®, LLaMa from Meta®, BERT from Google®, CLAUDE™ from Anthropic A.I., and FLAN-T5 form Google®. Components of the processes described herein can implement one or more language models currently developed or that may be developed in the future. In certain aspects, language model 150 is installed and hosted locally within job application generation system 110. In some aspects, language model 150 is utilized using application programming interface (API) calls.

Language models are sometimes distinguished as between a “large” language model (LLM) and a “small” language model (SLM) based on the size and complexity of the model, which affects their capabilities and applications. LLMs are often characterized by their large number of parameters, ranging from hundreds of millions to trillions of parameters. This extensive scale enables them to capture complex language patterns and nuances. LLMs are trained on vast datasets that often include diverse and extensive sources of text from the internet, books, articles, and various other textual corpora (e.g., domain-specific corpora). The large volume of training data contributes to their broad generalization capabilities. Due to their size and comprehensive training, LLMs exhibit excellent language understanding and generation abilities. Relatedly, LLMs require significant computational resources for both training and inference. This includes, for example, powerful hardware such as multiple GPUs or TPUs and substantial memory and storage capacity.

SLMs have a smaller number of parameters, compared to LLMs, often ranging from tens of thousands to a few hundred million parameters. This relatively smaller size bounds their ability to capture complex language patterns. SLMs are often trained on smaller datasets compared to LLMs. The training data is typically more focused and less diverse, aimed at specific tasks or domains. While SLMs can still perform various language-related tasks, their performance is usually limited compared to LLMs. However, SLMs require significantly fewer computational resources for training and inference. They can be run on more modest hardware setups, making them suitable for applications with constrained resources or where quick deployment is essential.

Thus, LLMs offer enhanced performance and versatility at the cost of higher computational resource requirements, while SLMs provide a more resource-efficient solution with limitations in performance and capabilities. The choice between an LLM and an SLM depends on the specific application requirements and resource constraints.

Job application generation system 110 is configured to perform processes for generating resumes based on user profile data for online job applications using one or more computing devices 112. The one or more computing devices 112 of job application generation system 110 include one or more processors 115 and one or more non-transitory computer-readable mediums storing computer readable instructions that, when executed by the one or more processors, cause the one or more computing devices to perform processes defined by computer-readable instructions corresponding to one or more components depicted and described herein.

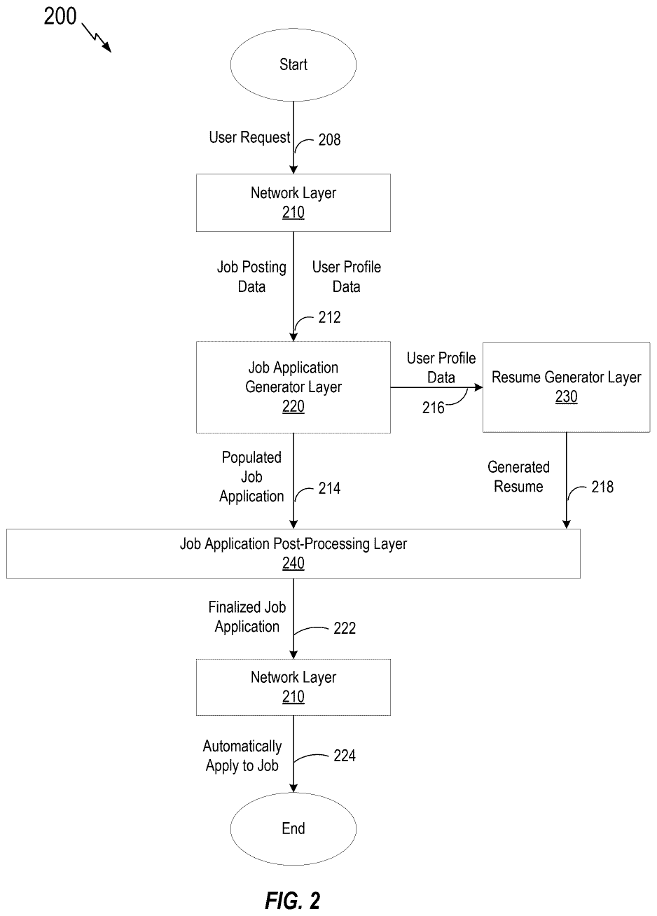

FIG. 2 depicts an illustrative system architecture 200 implemented by a job application generation system to perform an illustrative process for generating a resume for a job application based on user profile data according to one or more aspects.

At 208, a network layer 210 of job application generation system receives a user request to apply for an online job posting using a user profile associated with the user making the request. As used herein, a “layers” refer to groups of related components that are used for performing similar or related tasks performed by job application generation systems according to one or more aspects. The user request may be sent by a registered user of a job listing service employing a job application generation system according to one or more aspects described herein. In certain aspects, the job listing service may be a third party platform or application from which network layer 210 may extract data (e.g. user profiles, resumes, and other user information and data) for performing illustrative processes described herein. In some examples, the registered user may send the request to apply to the online job posting using their user profile via a selectable icon of a browser extension provided by described aspects.

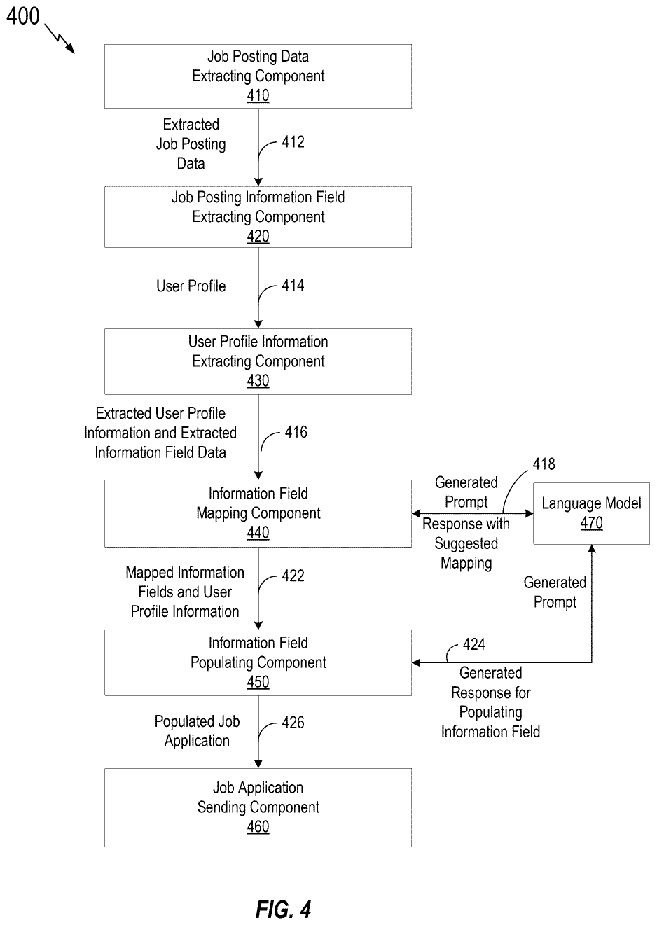

At 212, network layer 210 of the job application generation system sends user profile data and job posting data to a job application generator layer 220. For example, the network layer 210 may extract and send user profile data from an accessible database (such as accessible database 140 of FIG. 1) including user profiles for registered users of the job listing service interfacing with described aspects. Similarly, the network layer 210 may extract and send, from the accessible database, stored job posting data corresponding to online job postings maintained by the job listing service interfacing with described aspects. In some examples, network layer 210 may send user profile data and job posting data that has been retrieved from a third party web-based job listing service (for example, as described below with reference to job posting data extracting component 410 and user profile information extracting component 430 with reference to FIG. 4).

At 214, job application generator layer 220 generates a job application for the online job posting corresponding to the user request by leveraging the user profile data to generate and populate a job application for the online job posting. An illustrative process for leveraging user profile data to generate and populate a job application for an online job posting is depicted and described in greater detail below in connection with FIG. 4.

At 216, job application generator layer 220 sends the user profile data to a resume generator layer 230.

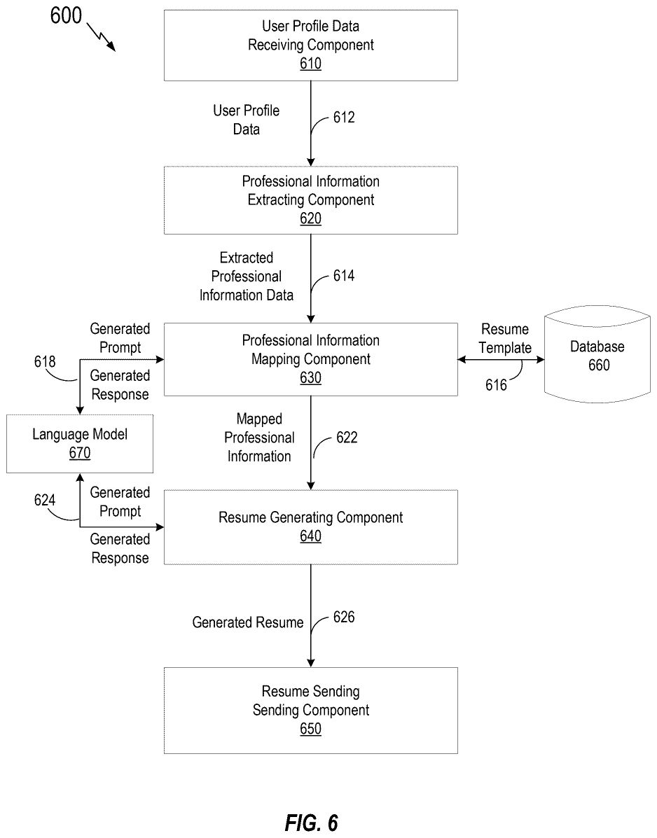

At 218, resume generator layer 230 is configured to further leverage the user profile data to generate a resume for the online job posting. An illustrative processes performed by a job application generation system in accordance with aspects herein for generating a resume based on user profile data is described in greater detail below in connection with FIG. 6.

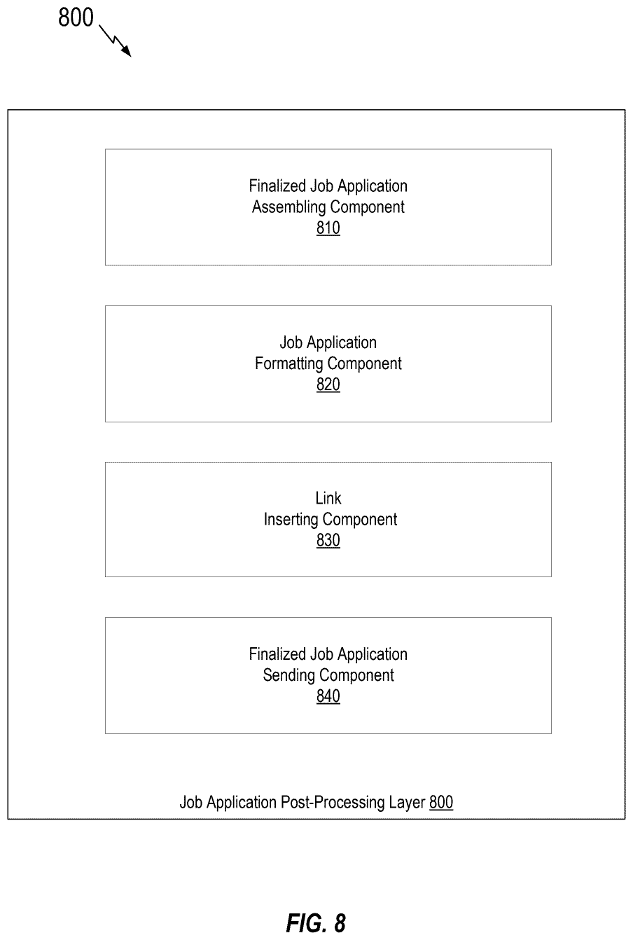

The populated job application and the generated resume are then provided to a job application post-processing layer 240 configured to integrate the populated job application and the generated resume into a finalized job application. As used herein a “finalized job application” refers to a completed job application that includes and/or is responsive to each component (e.g. documents, responses to questions or requested information, etc.) requested by an online job posting. To be responsive to each component requested by the online job application, the populated job application and the generated resume may be reformatted or modified by the job application post-processing layer 240. Components of job application post-processing layer 240 for reformatting and modifying generated job applications are depicted and described in greater detail below in connection with FIG. 8.

At 222, the job application post-processing layer 240 sends the finalized job application to the network layer.

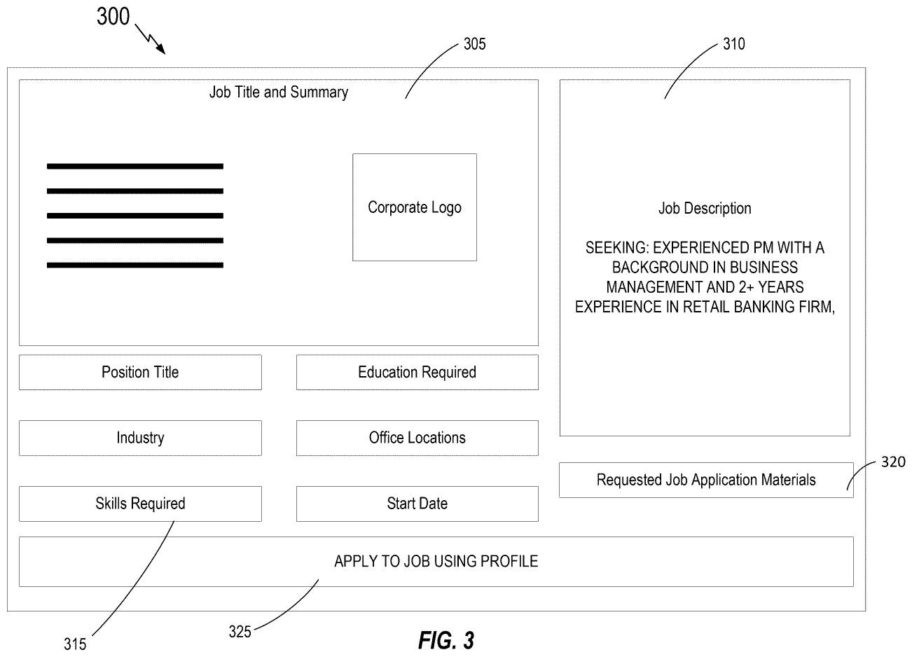

At 224, network layer 210 utilizes the finalized job application to automatically apply, for the user, to the online job posting. For example, network layer 210 may upload and submit the finalized job application for an online job posting using any suitable known mechanisms for transmitting data over a network (such as network 130 of FIG. 1) to send the finalized job application to a server associated with the online job posting. Suitable mechanisms for transmitting the finalized job application may include Hypertext Transfer Protocol (HTTP) requests or Application Programming Interface (API) calls for communicating with a server associated with a given online job posting. FIG. 3 depicts an illustrative online job posting 300 including an icon for requesting generation of a job application by a job application generation system according to one or more aspects shown and described herein.

Illustrative online job posting 300 may be stored within a job listing service (such as job listing service 120 of FIG. 1) employing a job application generation system as described herein. In certain aspects, the online job posting 300 is instead available via a job listing service that includes a third party web-based application or platform. The illustrative online job posting 300 includes a job title and summary 305 and a job description 310 detailing the job responsibilities for the job posting. Online job posting 300 may further include different job features 315, including but not limited to, position title, education requirements, industry, office locations, skills required, and a start date.

Online job posting 300 may further include requested job application materials 320. In certain aspects, requested job application materials 320 may include requested documents for upload, such as a resume, cover letter, reference letter, transcript, credential, or other document for upload. In some aspects, requested job application materials 320 further include questions or information fields to be filled out by the user when submitting a finalized job application responsive to online job posting 300.

Online job posting 300 further includes a selectable icon 325 configured to cause a user request to be sent to a job application generation system as described herein. The user request may be configured to cause the job application generation system to generate a resume and a populated job application based on a user profile and for inclusion within a finalized job application corresponding to the online job posting 300. For example, the selectable icon 325 may state “Apply to a Job with Profile.” The selectable icon provides the user the convenience of providing only a user profile to enable systems and methods described herein to utilize the user profile to generate a resume and job application based on the user profile for uploading and submitting on behalf of the user to an online job posting.

FIG. 4 depicts an illustrative process 400 implemented by a job application generation system for generating a job application based on user profile data according to one or more aspects shown and described herein.

As previously discussed, job application generation systems may be configured to perform illustrative process 400 in response to a user interacting with a selectable user interface element (such as selectable icon 325 of online job posting 300 of FIG. 3) to send a user request to apply to an online job posting using a user profile. As described, the selectable icon may be provided for a third party web-based job listing service via a suitable browser extension provided by described aspects. As used herein a ‘browser extension’ refers to a software program that adds functionality or features to a specific web browser. For example, the selectable icon within a given online job posting may be associated with a provided browser extension configured to send a user request to apply to the online job posting using a profile. The job application generation system may receive the user request and perform illustrative processes described herein by executing API calls, for example using the network layer (such as network layer 210 of FIG. 2), to perform illustrative processes for generating a resume and a job application based on user profile data.

Once a user request is received by the job application generation system, illustrative process 400 starts with a job posting data extracting component 410 of a job application generation system extracting relevant data from the online job posting corresponding to the received user request. For example, job posting data extracting component 410 may extract a job title and summary, a job description, requested application materials, and any other job features associated with the online job posting that may be useful for correlating information of the user's profile with the information for generating and populating a job application corresponding to the online job posting. In some examples, where a job listing service hosting the relevant job posting is a third party web-based application or platform, job posting data extracting component 410 may instead be configured to extract the job posting data directly from the job posting hosted on the job listing for example via an employed browser extension that interacts with a document object model of the user session, or via suitable parsing techniques where permitted.

Job posting data extracting component 410, and other extracting components described herein for extracting various information or data from user profiles, resumes, or other professional documents, may be configured to extract data by leveraging suitable known natural language processing and parsing techniques. For example, data and information extracting components (such as job posting data extraction component 410, job posting information field extracting component 420, and user profile information extracting component 430 of FIG. 4, and professional information extracting component 620 of FIG. 6) of job application generation systems described herein may be configured to employ section classification algorithms (e.g. Support Vector Machine (SVM) algorithms) for detecting keywords or phrases commonly associated with a given category or topic. As an example, a section classification algorithm may be used to extract a section including data related to “Work experience” based on detecting keywords or phrases commonly associated with work experience, such as “professional experience,” “work history,” or “employment.” In certain aspects, data and information extracting components may further utilize regular expressions (regex) or keyword-based matching to find certain section headers. In some aspects, data extracting components of a job application generation system may further utilize a named entity recognition (NER) model trained to extract specific information or data. In some aspects, data extracting components of a job application generation system as described herein may further utilize NLP techniques such as sentence segmentation, pattern recognition, relation extraction via dependency parsing, and other suitable NLP techniques as may be useful for extracting relevant information or data. In yet another example, data and information extracting components of job application generation systems described herein may be configured to send prompts to cause an accessible language models (not shown) to extract data or information from user profiles, resumes, or other professional documents as may be useful for applying to a given online job posting for a user.

At 412, the extracted job posting data is sent to a job posting information field extracting component 420. Job posting information field extracting component 420 is configured to extract relevant information fields that must be populated for generating a job application responsive to the online job posting. The extracted relevant information fields may each be associated with text including questions, requests, or statements to which a potential applicant may respond by providing input (text, numbers, etc.) including data that is responsive to the extracted information field. As an example, an extracted information field may pose a question to the user asking “Have you ever been employed within a retail banking firm?” Job posting information field extracting component 420 may scrape a given online job posting to extract data including, but not limited to, metadata, question format data, section headers, and contextual data.

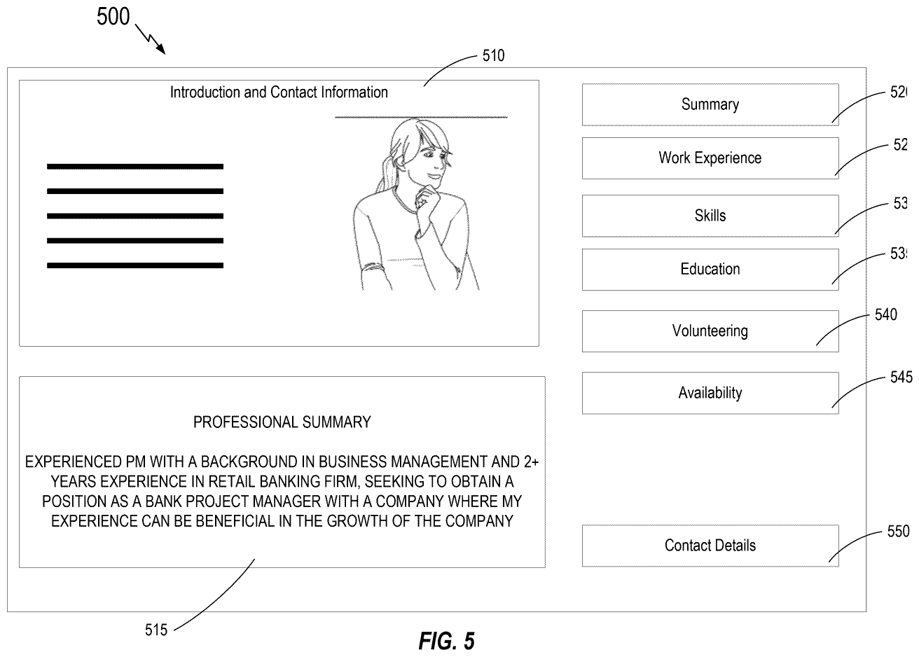

Simultaneously, a user profile information extracting component 430 extracts, from a user profile, information about the user. FIG. 5 describes an example of extracted user profile information from a user profile 500.

Referring to FIG. 5, illustrative user profile 500 may be created by a user of a job listing service employing a job application generation system in accordance with aspects described herein. User profile 500 may include a wide variety of personal and professional information related to the user.

In this example, user profile 500 includes an introduction and contact information section 510 including basic information about the user and information for corresponding with the user. For example, the introduction and contact information section may include the user's name, phone number, email, and other introductory or contact information included by the user.

User profile 500 further includes a professional summary 515. Professional summary 515 may include a sentence, paragraph, or section of text including information summarizing the user's past work experience and what type of job opportunity they are currently searching for. In certain aspects, professional summary 515 includes additional information manually input by the user during drafting of the professional summary 515 such as freeform text written by the user.

User profile 500 further include additional sections that may include written sentences, paragraphs, or sections of text related to a given category of information about the user. As an example, user profile 500 may include a section including a summary 520 to briefly describe the user's career goals and current professional undertakings. User profile 500 further includes a section including work experience 525 including a more detailed description of a user's previous employers, job titles, work experience, and the corresponding date ranges. User profile 500 further includes a section including skills 530. In certain aspects, skills 530 provide details of a user's talents, skills, tasks, expertise, or capabilities, possessed by the user.

User profile 500 further include a section including education 535 detailing the educational background of the user, such as degrees obtained, certifications, training, or information related to the educational or training background of the user. User profile 500 further includes a section including volunteering 540 detailing acts of service, charitable events, or volunteer opportunities that the user has engaged in throughout their career. User profile 500 further includes a section including availability 545 detailing the days of the week, times of day, or months of the year during which a user is available to work, to interview, or to otherwise engage with career related activities. User profile 500 further includes a contact details section 550. This section may include details about how best to contact or reach the user for the benefit of potential employers. For example, the contact details section may include the user's phone, email, or other available means for contacting the user.

While different sections are shown in user profile 500, it may be understood that additional sections or fewer sections may be included within any given user profile. Additionally, the volume information contained within a given user profile may vary from user to user.

Returning to illustrative process 400 of FIG. 4, at 414, the user's profile is provided to a user profile information extracting component 430 of the job application generation system. User profile information extracting component 430 then extracts, from the user profile, user profile information. The extracted user profile information may include information that is professional or personal, as the user information will be used to populate information fields for the extracted information fields of the job posting, which may include questions or fillable forms having diverse question types (professional and personal in nature.). Accordingly, the extracted user information from the user profile may be derived from one or more available sections of the user profile. As an example, user profile information extracting component 430 may parse the user profile to extract information related to the user's work experience, skills, education, contact information, interests and other section contained within the user profile (See for example illustrative sections of user profile 500 depicted and describe above in connection with FIG. 5.) For example, user profile information extracting component 430 may extract user profile information from a work experience section stating that the user has been employed as a project manager for two years. In some examples, where the job listing service is a third party web-based application or platform, information extracting component 430 may instead be configured to extract the user profile data directly from a user profile hosted on the job listing for example via an employed browser extension that interacts with a document object model of the user session, or via suitable parsing techniques where permitted.

At 416 the extracted information field data and the extracted user profile information are sent to an information field mapping component 440 of the job application generation system. Information field mapping component 440 then maps the extracted user profile information to the extracted information field data. In certain aspects, information field mapping component 440, may be configured to employ suitable known mapping algorithms for executing core logic to map extracted information or data from a user profile to a job application, resume template, or other professional document to be populated or filled out.

As an example, an extracted information field may request the user to input, as part of the job application, their years of experience working as a project manager. Information field mapping component 440 may then map extracted user profile information from the work experience section (for example, work experience 525 of user profile 500 of FIG. 5) of the user profile, detailing the user's number of years worked as a project manager, to an extracted information field (for example, based on a fillable information field derived from requested job application materials 320 of FIG. 3) requesting the user to input their number of years employed working as a project manager.

At 418, in certain aspects, information field mapping component 440 is configured to generate prompts for causing a language model 470 to generate a response indicating which of the extracted information fields certain extracted user profile information should be mapped to. For example, the generated prompt may cause the language model to generate a response to indicating a suggested mapping of certain extracted user profile information associated with the user's education to a most relevant extracted information field based on the extracted information field data (e.g. metadata, question format, section headers, etc.) Information field mapping component 440 may be configured to utilize the network layer (such as network layer 210 of FIG. 2) of the job application generation system to utilize API calls for sending and receiving information and data to the language model 470. Information field mapping component 440 may then map the extracted user profile information to the extracted information fields based on a received response from the language model.

In certain aspects, information field mapping component 440 is configured to instead utilize suitable known natural language processing techniques to perform entity recognition by identifying key information such as job titles, company names, dates, and skills within the extracted user profile data to map extracted user profile information to an extracted information field. In another example, information field mapping component 440 employs suitable known text similarity algorithms to compare the extracted user profile data to predefined categories associated with the extracted information fields of the online job posting to find a most relevant match. In yet another example, information field mapping component 440 may utilize synonym detection and contextual mapping to map the extracted user profile data with extracted information fields by comparing similar terms and headers.

At 422, the mapped information fields and the user profile data are sent to an information field populating component 450 of the job application generation system. Information field populating component 450 is configured to populate the extracted information fields of the job application based on the mapped information fields and corresponding user profile data to generate a populated job application responsive to the online job posting.

In certain aspects, at 424, information field populating component 450 may be configured to generate a prompt for causing language model 470 to generate a response for populating a given extracted information field based on the extracted user profile information. For example, described aspects may leverage language model 470 to act as a question-response service for populating fields of the job application. Returning to the previous example, information field populating component 450 may populate the extracted information field of the job application requesting the user respond with the number of years the user has been employed as a project manager. Information field populating component 450 may generate a prompt, using the extracted user profile information that was mapped to the extracted information field as input. For example, the extracted user profile information that was mapped to the extracted information field may include information about the number of years the user has been employed as a project manager. The generated prompt then causes the language model 470 to generate a natural language response for populating the extracted information field by using the extracted user profile information (corresponding to the years the user has been employed as a project manager) as input, yielding accurate and precise responses for populating the extracted information field. In certain aspects, the network layer (such as network layer 210 of FIG. 2) may be used by the information field populating component 450 to send the generated prompt to the language model 470. Language model 470 may then send the generated response for the received prompt back to the information field populating component 450. In certain aspects, information field populating component 450 may instead populate the mapped information fields using natural language processing techniques corresponding to what is used to map the extracted user profile information to the extracted information fields. For example, if the job application generation system utilizes text similarity algorithms for mapping the extracted user profile information to the extracted information fields based on semantic similarity, then information field populating component 450 may similarly utilize a semantic similarity-based approach for populating the information fields. For example, if extracted user profile information indicating that a job seeker has “two years of experience as a project manager” is determined to be semantically similar to an extracted information field asking “how many years of experience do you have as a project manager,” then information field populating component 450 may populate the extracted information field with the text of the extracted user profile information. In certain aspects, information field populating component 450 will only populate a given extracted information field if the semantic similarity between the extracted information field and the corresponding extracted user profile information is above a threshold. As another example, information field populating component 450 may instead utilize named entity recognition to populate extracted and mapped information fields based on extracted user profile information. Returning to the previous example, information field populating component 450 may populate a first extracted information field asking for “years of experience” with “two years,” and a second extracted information field asking for “job title” with “project manager.” In some aspects, information field populating component 450 may instead utilize suitable known text classification techniques, dependency parsing, rule-based systems, or may be configured to employ decision logic for utilizing a combination of any of the previously discussed techniques for populating extracted information fields. Information field populating component 450 may continuously populate extracted information fields until all information fields for a target job application have been populated.

At 426, a populated job application (having all extracted information fields populated with a response) is sent to a job application sending component 460 of the job application generation system. The job application sending component 460 may subsequently send the populated job application to the job application post-processing layer (such as job application post-processing layer 240 previously described in FIG. 2.) The job application post-processing layer is described in greater detail in connection with FIG. 8 below.

As previously discussed, online job postings often require a user to submit both a job application and a resume. Accordingly, aspects described herein are configured to generate both a job application and a resume based on a given user profile in order to create and submit a finalized job application for a given job posting.

FIG. 6 depicts an illustrative process 600 implemented by a job application generation system for generating a resume based on user profile data according to one or more aspects shown and described herein.

To generate a resume from a user profile, a user profile data receiving component 610 of the resume generator layer (such as resume generator layer 230 of FIG. 2) receives the user profile data from the job application generator.

At 612, the user profile data is sent to a professional information extracting component 620 configured to extract professional information data from the received user profile data. As used herein, “professional information” may include information such as work experience, skills, availability, contact information, education, or any other information that may be useful for purposes of generating a resume to be submitted for applying to an online job posting.

At 614, extracted professional information is provided to a professional information mapping component 630 configured to map the extracted professional information data to sections of a suitable resume template.

For example, at 616 professional information mapping component 630 may be configured to automatically select a suitable resume template available within an accessible database 660 associated with the job application generation systems according to described aspects. In certain aspects, the suitable resume template may be selected based upon attributes of the user. For example, professional information mapping component 630 may be select a first suitable resume template for a user with two or less years of experience that is structurally suited for highlighting education, certifications, and internships. Professional information mapping component 630 may instead select a second different suitable resume template (from the database 660) for a user having fifteen years of experience that is designed with a layout having longer sections dedicated to emphasizing leadership roles, strategic projects, and major achievements. In certain aspects, the resume template may be selected from the database based on a predetermined list of resume templates associated with certain user profile designs. For example, a user profile specifically designed for a professional data entry analyst may be associated with a stored resume template within the database 660. In certain aspects, the user may be prompted via the user interface of the job application generation system, or the job listing service (such as user interface 125 of the job listing service 120) to select a resume template.

As previously discussed, described aspects generate resumes based on the use of resume templates that are consistent, and designed to reduce the risk that the resume is rejected as incompatible with applicant tracking system (ATS) platforms. Accordingly, the resume templates used by described aspects to generate resumes utilize standard file formats accepted by ATS platforms (e.g. PDF or DocX), have simple layouts and structures (using standard section headers, linear top-to-bottom designs, reduced use of graphics or images, reduced use of columns, etc. ,) standard fonts, standard bullets for listing skills, responsibilities, and achievements, and consistent formatting (e.g. uniform margins, spacing, and font styles.) Resume templates used by described aspects are further designed to restrict the use of special characters, tables, text boxes, or special fonts that may be rejected by certain ATS platforms. Accordingly, described aspects provide the technical benefit of reducing errors or incompatibilities during data transfer processes for submitting a finalized job application. Described aspects further provide the technical benefit of reducing likelihood of failed submissions and improving generated resume compatibility with various ATS platforms.

In certain aspects, the professional information mapping component 630 may employ similar techniques for mapping extracted professional information data to sections of a suitable resume template as are utilized by the information field mapping components (such as information field mapping component 440 of FIG. 4.) For example, at 618 professional information mapping component 630 may generate a prompt with the extracted professional information data and sections of the selected resume template as an input. The generated prompt may then be provided to a language model 670 to cause the language model to generate a response corresponding to a determination of a most relevant section of the selected resume template for mapping to the extracted professional information data being considered. Professional information mapping component 630 may then receive the response from the language model 670 and map the extracted professional information to the indicated section of the selected resume template.

In certain other aspects, professional information mapping component 630 may instead employ text similarity algorithms (for performing semantic similarity analyses), named entity recognition techniques, text classification techniques, synonym detection and contextual mapping techniques, or other suitable natural language processing techniques for mapping the extracted professional information from the user profile to sections of the selected resume template (as previously discussed above with reference to information field mapping component 440 of FIG. 4.) At 622, the mapped professional information is sent to a resume generating component 640 of the job application generation system to generate a completed resume by filling in a resume template based on the mapped professional information from the user profile. Resume generating component 640 may be configured to utilize similar techniques as are employed by previously described information field populating components (such as information field populating component 450 of FIG. 4) of job application generation systems according to described aspects.

For example, at 624, resume generating component 640 may be configured to generate a prompt for causing language model 670 to generate responses for populating sections of the resume template based on input including the extracted and mapped professional information from the user profile. For example, the language model 670 may generate a natural language response for converting the extracted professional information from the user profile to suitable language for a corresponding mapped section of the selected resume template. In certain aspects, resume generating component 640 may instead populate the resume template by employing text similarity algorithms for determining semantic similarity between extracted professional information and mapped sections of the selected resume template. As another example, resume generating component 640 may instead utilize named entity recognition techniques to populate sections of the selected resume template based on extracted user profile information. In some aspects, resume generating component 640 may instead utilize suitable known text classification techniques, dependency parsing, rule-based systems, or may be configured to employ decision logic for utilizing a combination of any of the previously discussed techniques for generating a resume based on the extracted professional information from the user profile and the selected resume template. Thus, systems and methods described herein utilize information extracted from a user profile to generate a resume based on a template. Systems and methods herein described automate processes previously performed by a user, reducing the amount of time a user must invest into preparing a resume for a finalized job application, and further reducing the risk of human error during creation and uploading of the resume within a finalized job application. Systems and methods described herein further provide improved convenience for the user, as the user is only responsible for providing a user profile to apply for an online job posting.

At 626, the generated resume is sent to a resume sending component 650 of the job application generation system. Resume sending component 650 then sends the generated resume to the job application post-processing layer of the job application generation system (such as the illustrative job application post processing layer 800 of FIG. 8).

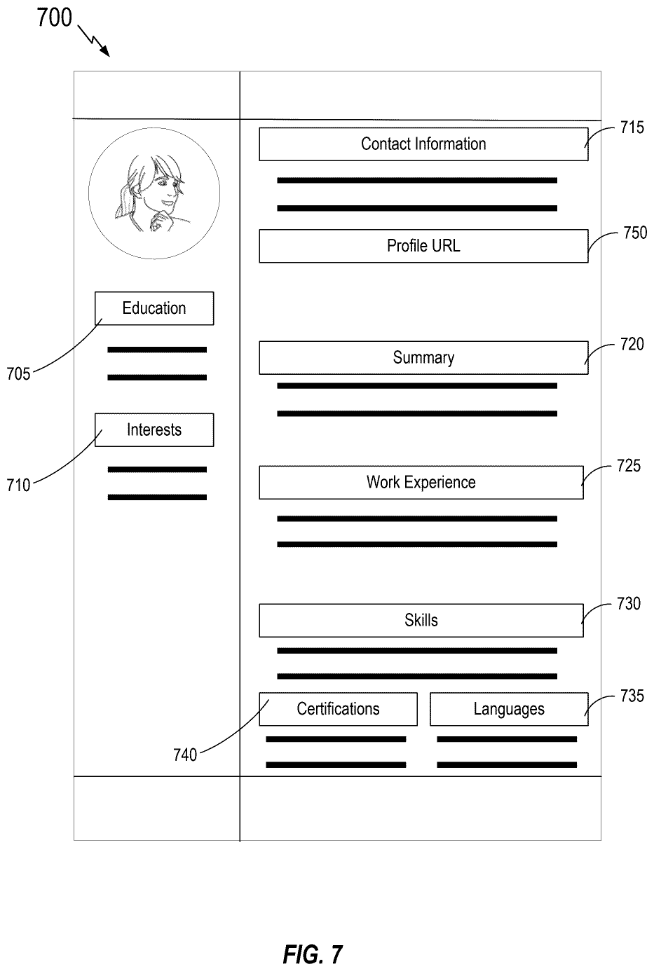

FIG. 7 depicts an illustrative resume 700 generated based on user profile data by a job application generation system implementing illustrative processes of generating a resume in accordance with one or more aspects shown and described herein.

As previously discussed, illustrative resume 700 may be generated by resume generator layer 230 of job application generation system 110 by mapping extracted professional information from a user profile to sections of a resume template. The mapped professional information may then be used to populate the resume template to generate a completed resume, such as illustrative resume 700.

In certain aspects, a resume generated by the job application generation systems described herein is based on a resume templates including different sections therein. As an example, illustrative resume 700 includes sections for showcasing the user's education 705, interests 710, contact information 715, summary 720, work experience 725, skills 730, language 735, and certifications 740, and a profile URL 750.

In certain aspects, job application generation systems as described herein may be configured to leverage a job application post-processing layer (such as job application post-processing layer 240 of FIG. 2) to generate a finalized job application by integrating the populated job application with the generated resume, applying any formatting modifications, inserting any additional features, and finally sending the finalized job application to the network layer for uploading and submission.

FIG. 8 depicts illustrative job application post-processing layer 800 of a job application generation system to perform illustrative methods for post-processing of a generated resume according to one or more aspects shown and described herein.

Illustrative job application post-processing layer 800 includes a finalized job application assembling component 810, a job application formatting component 820, a link inserting component 830, and a finalized job application sending component 840 for performing methods of post-processing generated job applications for an online job posting.

Finalized job application assembling component 810 is configured to assemble the generated job application, the generated resume, and any other application materials into a finalized job application that may be uploaded for applying to the online job posting having certain requirements. For example, finalized job application assembling component 810 may be configured to generate a singular PDF file for an online job posting requiring that a finalized job application include all materials and documents, such as a resume and a cover letter, within a singular PDF file. In certain aspects, the finalized job application assembling component 810 may further be configured to convert the generated job application or generated resume into a specific format (e.g. from PDF to DOCX) based on the requirements of the online job posting.

Job application post-processing layer 800 further includes a job application formatting component 820 configured to reposition or modify text or other information within the generated job application or the generated resume for the purpose of ensuring the layout and formatting of the finalized job application match any specific formatting requested within the online job posting. As an example, a job posting may indicate that the job application and a resume should be uploaded in a singular document no longer than three pages in length. Accordingly, job application formatting component 820 may be configured to adjust the length, formatting, and/or layout of the generated job application and the generated resume to combine the two into a singular document no longer than two pages in length.

In certain aspects, the job application generation system further includes a link inserting component 830. Link inserting component 830 may be configured to generate and insert a link including a uniform resource locator (URL) for accessing a user profile (such as profile URL 750 of FIG. 7) within a generated resume included in a finalized job application. This allows the employer easy access to the user profile of the user when they are reviewing the generated resume. In certain aspects, link inserting component 830 is further configured to embed, within the inserted link, tracking parameters for tracking potential employer interactions with the inserted link. The tracking parameters may be used to provide users with updates regarding interactions with their uploaded finalized job applications based on potential employers clicking the link to their user profile within the generated resume of the finalized job application. For example, the embedded link may be constructed by link inserting component 830 to include a URL having an appended query string with key-value pairs configured to track specific details which may include, but are not limited to, a source of traffic, a medium through which the link was shared, or a time stamp. In some examples, described aspects may further insert the link into a cover letter or other attachment.

In certain aspects, the link inserting component 830 is configured to embed, within the generated resume, a link including a URL for accessing an updated user profile including a copy of the generated resume in HTML format. Thus, if a potential employer viewing a finalized job application clicks the URL within the generated resume, they are taken to the updated user profile, where they can easily view both the user profile information and an HTML version of the generated resume simultaneously. In certain aspects, job application formatting component 820 may be further configured to generate the updated version of the user profile (for example, the user profile 500 of FIG. 5) to include a copy of the generated resume in hypertext markup language (HTML) format by adding and repositioning the HTML version of the generated resume within the body of the user profile. In certain aspects, the updated resume may allow the user to switch between a first view including only the user profile, and a second view including the HTML version of the generated resume. For example, the link inserting component 830 may further insert a selectable link reading “Resume View” for allowing the user to switch from a first view of the profile to the second view of the HTML resume. In some examples, the updated version of the user profile may be accessible via user interaction with a tab of a linked user profile. For example, a tab may state “Resume View”, allowing a reviewer to view the user's resume upon activation of the tab. Described aspects including a tab for viewing an updated version of the resume provides the benefit of ensuring that a reviewer is able to always see a latest version of the resume, overcoming the challenge of handling the dynamic nature of resumes becoming stale over time.

After a finalized job application is processed by the previously described components of job application post-processing layer 800, a finalized job application sending component 840 may be configured to send the finalized job application back to a network layer (such as network layer 210 of FIG. 2) of the job application generation system. The network layer may then upload the finalized job application on behalf of the user, via the job listing service, as a submission for the online job posting. Beneficially, the job application generation systems described herein perform methods of generating resumes based on user profile data for online job applications that allows for automatic upload and submission of finalized job applications without requiring the user to manually create or upload a resume. From the perspective of the user, a request is made to apply to one or more online job postings by selecting an icon (such as selectable icon 325 of FIG. 3) to apply to an online job posting using only a user profile. Receiving the user request then causes the job application generation system to perform methods described above to generate finalized job application materials based on the user information and professional information contained within the user profile. Furthermore, job application generation systems described herein upload finalized job applications without the user reviewing or manually modifying the finalized applications, reducing the time investment on the part of the user.

In some examples, described aspects may be configured to allow a user to apply to recommended online job postings of a given job listing service using their user profile. For example, described aspects may be configured to display, via a suitable user interface (such as user interface 125 with reference to FIG. 1) of a job listing, a selectable icon configured to send a user request to the job application generation system to apply to one or more recommended jobs using the user profile. In some examples, described aspects may be configured to overlay the selectable icon over the user interface of a given third party job listing service using a suitable web-browser extension (e.g. a plugin) provided by described aspects (such as by computing devices 112 with reference to FIG. 1). The suitable web-browser extension may be configured to work with multiple web browser types. In certain aspects, the user of the job listing service may grant permission, via an interaction with the user interface of the job listing service, for job applications to be sent out on the user's behalf to the recommended online job postings. Described aspects may then generate job applications and resumes for applying to the recommended online job postings based on the user profile without the user sending user requests for each of the recommended job postings. Rather, the networking layer in accordance with described aspects (such as network layer 210 of FIG. 2) may receive the recommended online job posting materials and data from the job listing service, to allow the job application generation system to perform previously described methods to automatically apply to the online job posting based on the user's profile. In some aspects, the job listing service collects recommended online job postings based on identifying recommended jobs sharing keywords, tagged categories, job features, or a combination thereof with one or more jobs to which the user has previously applied. This allows a user to automatically apply to multiple recommended jobs stored within the job listing service, by leveraging described aspects to automatically generate job applications and resumes based on the user's profile for applying to the recommended jobs.

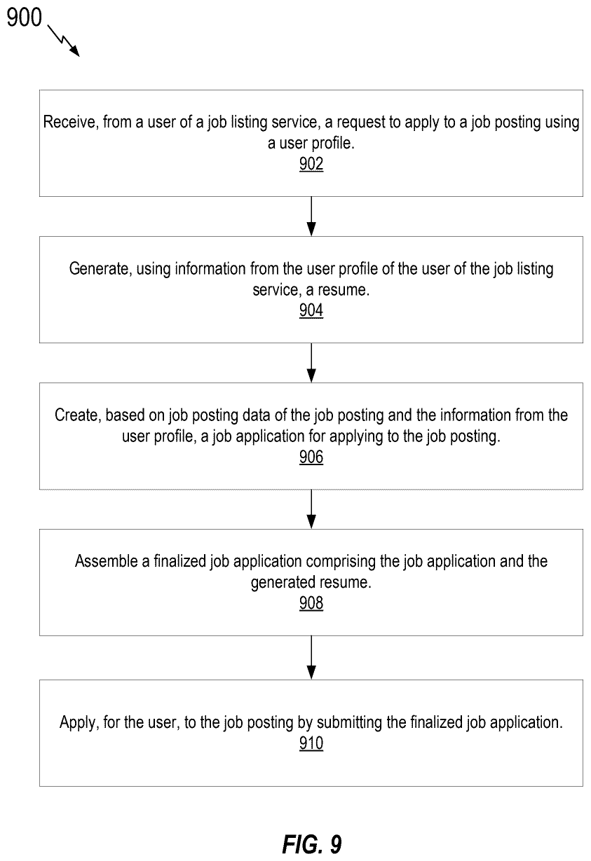

FIG. 9 depicts a method 900 for generating a resume for a job application based on user profile data according to one or more aspects shown and described herein.

In this example, method 900 begins at block 902 with receiving, from a user of a job listing service, a request to apply to a job posting using a user profile. For example, the receiving may be performed by one or more computing devices of a job application generation system, such as computing devices 112 of job application generation system 110 described above with reference to FIG. 1, configured to implement a network layer, such as the network layer 210 described above with reference to FIG. 2.

Method 900 then proceeds to block 904 with generating, using information from the user profile of the user of the job listing service, a resume. For example, the generating may be performed by one or more computing devices of a job application generation system, such as computing devices 112 of job application generation system 110 described above with reference to FIG. 1, configured to implement a resume generating component, such as the resume generating component 640 described above with reference to FIG. 6.

Method 900 then proceeds to block 906 with creating, based on job posting data of the job posting and the information from the user profile, a job application for applying to the job posting. For example, the creating may be performed by one or more computing devices of a job application generation system, such as computing devices 112 of job application generation system 110 described above with reference to FIG. 1, configured to implement components including but not limited to the job posting data extracting component 410, the job posting information field extracting component 420, the user profile information extracting component 430, the information field mapping component 440, and the information field populating component 450 described above with reference to FIG. 4.

Method 900 then proceeds to block 908 with assembling a finalized job application comprising the job application and the generated resume. For example, the assembling may be performed by one or more computing devices of a job application generation system, such as computing devices 112 of job application generation system 110 described above with reference to FIG. 1, configured to implement a finalized job application assembling component, such as the finalized job application assembling component 810 described above with reference to FIG. 8.

Method 900 then proceeds to block 910 with applying, for the user, to the job posting by submitting the finalized job application. For example, the applying may be performed by one or more computing devices of a job application generation system, such as computing devices 112 of job application generation system 110 described above with reference to FIG. 1, configured to implement a network layer, such as the network layer 210 described above with reference to FIG. 2.

In some aspects, method 900 further includes embedding, within the generated resume, a link comprising a URL for accessing the user profile associated with the user of the job listing service. In some aspects, the link further comprises a tracking parameter for tracking one or more interactions with the link.

In some aspects, method 900 further includes receiving the request to apply to the job using the user profile based on a user interaction with a browser extension.

In some aspects, method 900 further includes creating the job application for applying to the job posting by extracting, from the job posting, unpopulated information fields; mapping, to the unpopulated information fields, user information from the user profile associated with the user of the job listing service; and populating the unpopulated information fields based on the mapped user information from the user profile associated with the user of the job listing service.

In some aspects, method 900 further includes embedding, within the generated resume, a link comprising a uniform resource locator (URL) for accessing an updated user profile associated with the user of the job listing service, the updated user profile comprising a copy of the generated resume in hypertext markup language (HTML) format.

In some aspects, method 900 further includes generating the resume by extracting, from the user profile, professional information associated with the user; mapping, to a resume template, the extracted professional information; and populating the resume template based on the mapped professional information.

In some aspects, method 900 further includes receiving, from a job listing service, one or more recommended job postings for a user based on a previously submitted job application; automatically applying to the one or more recommended job postings using a user profile by: generating, using information from the user profile of the user of the job listing service, a resume; creating, based job posting data of the one or more recommended job postings and the information from the user profile, a job application for applying to the one or more recommended job postings; assembling a finalized job application comprising the job application and the generated resume; and automatically applying, for the user, to the one or more recommended job postings by submitting the finalized job application.

Method 900 thus provides technical solutions to technical problems of conventional techniques. By automatically generating finalized job applications for an online job posting, including generated resumes and populated job applications, described systems and methods automate processes previously performed by a user, reducing the amount of time a user must invest into preparing and uploading a finalized job application including a resume, and further reducing the risk of human error. Described systems and methods including such technical solutions further provide for various technical benefits. As an example, described aspects generate resumes for finalized job applications having uniform and optimized formats, minimizing errors or incompatibilities during data transfer processes. The generated resumes and finalized job applications may further provide the technical benefit of reducing likelihood of failed submissions and improving compatibility with various applicant tracking system (ATS) platforms, reducing the need for additional processing or conversions that might slow down application handling by the entity from which an online job posting is derived. Furthermore, described systems and methods may lower the volume of unstructured file uploads by users, thereby reducing bandwidth used during submission processes.

Note that FIG. 9 is just one example of a method, and other methods including fewer, additional, or alternative operations are possible consistent with this disclosure.

### Example Computing Devices for Generating Resumes from User Profile Data for Online Job Applications

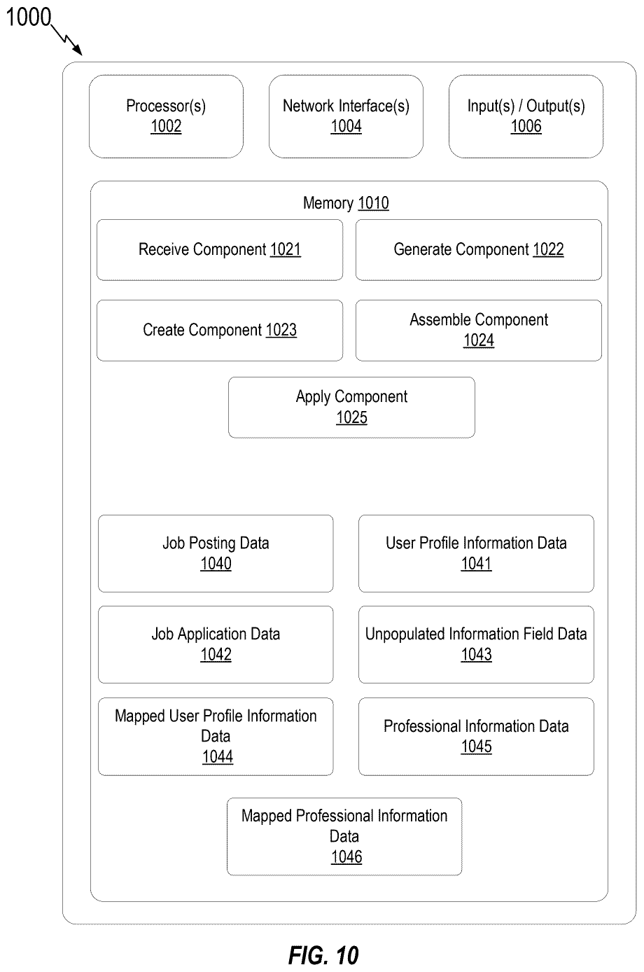

FIG. 10 schematically depicts an example computing device for enabling a job application system for generating a resume for a job application based on user profile data according to one or more aspects shown and described herein.

The computing device 1000 includes one or more processors 1002. Generally, processor(s) 1002 may be configured to execute computer-executable instructions (e.g., software code) to perform various functions, as described herein.

The computing device 1000 further includes a network interface(s) 1004, which generally provides data access to any sort of data network, including personal area networks (PANs), local area networks (LANs), wide area networks (WANs), the Internet, and the like.

The computing device 1000 further includes input(s) and output(s) 1006, which generally provide means for providing data to and from the computing device 1000, such as via connection to computing device peripherals, including user interface peripherals.

The computing device 1000 further includes a memory 1010 configured to store various types of components and data.

In this example, memory 1010 includes a receive component 1021, a generate component 1022, a create component 1023, an assemble component 1024, and an apply component 1025.

Receive component 1021 may be configured to perform processes, for example, corresponding to block 902 of method 900 depicted and described with reference to FIG. 9.

Generate component 1022 may be configured to perform processes, for example, corresponding to block 904 of the method 900 depicted and described with reference to FIG. 9.

Create component 1023 may be configured to perform processes, for example, corresponding to block 906 of method 900 depicted and described with reference to FIG. 9.

Assemble component 1024 may be configured to perform processes for example, corresponding to block 908 depicted and described with reference to FIG. 9.

Apply component 1025 may be configured to perform processes, for example, corresponding to block 910 of method 900 depicted and described with reference to FIG. 9.

In this example, memory 1010 also includes job posting data 1040, user profile information data 1041, job application data 1042, unpopulated information field data 1043, mapped user profile information data 1044, personal information data 1045, and mapped professional information data 1046.

The computing device 1000 may be implemented in various ways. For example, the computing device 1000 may be implemented within on-site, remote, or cloud-based computing devices.

The computing device 1000 is just one example, and other configurations are possible. For example, in alternative embodiments, aspects described with respect to the computing device 1000 may be omitted, added, or substituted for alternative aspects.

### Example Clauses

Implementation examples are described in the following numbered clauses:
Clause 1: A method comprising: receiving, from a user of a job listing service, a request to apply to a job posting using a user profile; generating, using information from the user profile of the user of the job listing service, a resume; creating, based on job posting data of the job posting and the information from the user profile, a job application for applying to the job posting; assembling a finalized job application comprising the job application and the generated resume; and applying, for the user, to the job posting by submitting the finalized job application.
Clause 2: The method of Clause 1 further comprising embedding, within the generated resume, a link comprising a uniform resource locator (URL) for accessing the user profile associated with the user of the job listing service.
Clause 3: The method of any of Clauses 1-2, wherein the link further comprises a tracking parameter for tracking one or more interactions with the link.
Clause 4: The method of any of Clauses 1-3, wherein the request to apply to the job using the user profile is received based on a user interaction with a browser extension.
Clause 5: The method of any of Clauses 1-4, wherein creating the job application for applying to the job posting further comprises: extracting, from the job posting, unpopulated information fields; mapping, to the unpopulated information fields, user information from the user profile associated with the user of the job listing service; and populating the unpopulated information fields based on the mapped user information from the user profile associated with the user of the job listing service.
Clause 6: The method of any of Clauses 1-5, further comprising embedding, within the generated resume, a link comprising a uniform resource locator (URL) for accessing an updated user profile associated with the user of the job listing service, the updated user profile comprising a copy of the generated resume in hypertext markup language (HTML) format.
Clause 7: The method of any of Clauses 1-6, further comprising: extracting, from the user profile, professional information associated with the user; mapping, to a resume template, the extracted professional information; and populating the resume template based on the mapped professional information.
Clause 8: A method comprising: receiving, from a job listing service, one or more recommended job postings for a user based on a previously submitted job application; automatically applying to the one or more recommended job postings using a user profile by: generating, using information from the user profile of the user of the job listing service, a resume; creating, based job posting data of the one or more recommended job postings and the information from the user profile, a job application for applying to the one or more recommended job postings; assembling a finalized job application comprising the job application and the generated resume; and automatically applying, for the user, to the one or more recommended job postings by submitting the finalized job application.
Clause 9: The method of Clause 8, further comprising: embedding, within the generated resume, a link comprising a uniform resource locator (URL) for accessing the user profile associated with the user of the job listing service.
Clause 10: The method of Clauses 9, wherein the link further comprises a tracking parameter for tracking one or more interactions with the link.
Clause 11: The method of any of Clauses 8-10, wherein creating the job application for applying to the one or more recommended job postings further comprises: extracting, from the job posting, unpopulated information fields; mapping, to the unpopulated information fields, user information from the user profile associated with the user of the job listing service; and populating the unpopulated information fields based on the mapped user information from the user profile associated with the user of the job listing service.
Clause 12: The method of any of Clauses 8-11, further comprising embedding, within the generated resume, a link comprising a uniform resource locator (URL) for accessing an updated user profile associated with the user of the job listing service, the updated user profile comprising a copy of the generated resume in hypertext markup language (HTML) format.
Clause 13: The method of any of clauses 8-12, wherein generating the resume further comprises: extracting, from the user profile, professional information associated with the user; mapping, to a resume template, the extracted professional information; and populating the resume template based on the mapped professional information.
Clause 14: A processing system, comprising means for performing a method in accordance with any one of Clauses 1-13.
Clause 15: A non-transitory computer-readable medium comprising computer-executable instructions that, when executed by one or more processors of a processing system, cause the processing system to perform a method in accordance with any one of Clauses 1-13.
Clause 16: A computer program product embodied on a computer-readable storage medium comprising code for performing a method in accordance with any one of Clauses 1-13.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method comprising:
receiving, from a user of a job listing service, a request to apply to a job posting using a user profile;
in response to receiving the request to apply to the job posting using the user profile. generating a resume using information from the user profile by:
extracting, from the user profile, professional information associated with the user;
mapping to a resume template, the extracted professional information; and
populating the resume template based on the mapped professional information;
creating, based on job posting data of the job posting and the information from the user profile, a job application for applying to the job posting;
assembling a finalized job application comprising the job application and the generated resume; and
applying, for the user, to the job posting by submitting the finalized job application.

2. The method of claim 1, further comprising embedding, within the generated resume, a link comprising a uniform resource locator (URL) for accessing the user profile associated with the user of the job listing service.

3. The method of claim 2, wherein the link further comprises a tracking parameter for tracking one or more interactions with the link.

4. The method of claim 1, wherein the request to apply to the job posting using the user profile is received based on a user interaction with a browser extension.

5. The method of claim 1, wherein creating the job application for applying to the job posting further comprises:
extracting, from the job posting, unpopulated information fields;
mapping, to the unpopulated information fields, user information from the user profile associated with the user of the job listing service; and
populating the unpopulated information fields based on the mapped user information from the user profile associated with the user of the job listing service.

6. The method of claim 1, further comprising embedding, within the generated resume, a link comprising a uniform resource locator (URL) for accessing an updated user profile associated with the user of the job listing service, the updated user profile comprising a copy of the generated resume in hypertext markup language (HTML) format.

7. (canceled)

8. A processing system, comprising:
one or more memories comprising computer-executable instructions; and one or more processors configured to execute the computer-executable instructions causing the processing system to:
receive, from a user of a job listing service, a request to apply to a job posting using a user profile;
in response to receipt of the request to apply to the job posting using the user profile, generate a resume using information from the user profile by causing the processing system to:
extract from the user profile, professional information associated with the user;
map, to a resume template, the extracted professional information; and
populate the resume template based on the mapped professional information;
create, based on job posting data of the job posting and the information from the user profile, a job application for applying to the job posting;
assemble a finalized job application comprising the job application and the generated resume; and
apply, for the user, to the job posting by submitting the finalized job application.

9. The processing system of claim 8, wherein the one or more processors are further configured to cause the processing system to embed, within the generated resume, a link comprising a uniform resource locator (URL) for accessing the user profile associated with the user of the job listing service.

10. The processing system of claim 9, wherein the link further comprises a tracking parameter for tracking one or more interactions with the link.

11. The processing system of claim 8, wherein the request to apply to the job posting using the user profile is received based on a user interaction with a browser extension.

12. The processing system of claim 8, wherein to create the job application for applying to the job posting, the one or more processors are further configured to cause the processing system to:
extract, from the job posting, unpopulated information fields;
map, to the unpopulated information fields, user information from the user profile associated with the user of the job listing service; and
populate the unpopulated information fields based on the mapped user information from the user profile associated with the user of the job listing service.

13. The processing system of claim 8, wherein the one or more processors are further configured to cause the processing system to embed, within the generated resume, a link comprising a uniform resource locator (URL) for accessing an updated user profile associated with the user of the job listing service, the updated user profile comprising a copy of the generated resume in hypertext markup language (HTML) format.

14. (canceled)

15. A method comprising:
receiving, from a job listing service, one or more recommended job postings for a user based on a previously submitted job application;
receiving a request from the user to apply to the one or more recommended job postings using a user profile;
in response to receiving the request to apply to the one or more recommended job postings using the user profile automatically generating, using information from the user profile associated with the user a resume by:
extracting, from the user profile, professional information associated with the user;
mapping, to a resume template, the extracted professional information; and
populating the resume template based on the mapped professional information;
creating, based on job posting data of the one or more recommended job postings and the information from the user profile, a job application for applying to the one or more recommended job postings;
assembling a finalized job application comprising the job application and the generated resume; and
automatically applying, for the user, to the one or more recommended job postings by submitting the finalized job application.

16. The method of claim 15, further comprising: embedding, within the generated resume, a link comprising a uniform resource locator (URL) for accessing the user profile associated with the user of the job listing service.

17. The method of claim 16, wherein the link further comprises a tracking parameter for tracking one or more interactions with the link.

18. The method of claim 15, wherein creating the job application for applying to the one or more recommended job postings further comprises:
extracting, from the one or more recommended job postings, unpopulated information fields;
mapping, to the unpopulated information fields, user information from the user profile associated with the user of the job listing service; and
populating the unpopulated information fields based on the mapped user information from the user profile associated with the user of the job listing service.

19. The method of claim 15, further comprising embedding, within the generated resume, a link comprising a uniform resource locator (URL) for accessing an updated user profile associated with the user of the job listing service, the updated user profile comprising a copy of the generated resume in hypertext markup language (HTML) format.

20. (canceled)

21. The method of claim 1, wherein the resume is generated in a format that is compatible with an applicant tracking system (ATS) based on incorporating one or more of a set of fonts accepted by the ATS or a file format accepted by the ATS.

22. The method of claim 1, wherein:
generating the resume using information from the user profile further comprises selecting, from a database storing a set of resume templates, the resume template for generating the resume based on a set of attributes of the user, and
the set of attributes of the user comprises one or more of a number of years of experience of the user, or a profile design of the user profile associated with the user.

23. The method of claim 2, wherein the URL of the link further comprises an appended query string with key-value pairs configured to track one or more of a source of traffic, a medium through which the link was shared, or a time stamp for an interaction associated with the link.
